(19) United States
(12) Patent Application Publication
(10) Pub. No.: US 2002/0019759 A1
(43) Pub. Date: Feb. 14, 2002

(54) Transportation planning, execution, and freight payments managers and related methods

(76) Inventors: Sundararajan Arunapuram, West Chester, PA (US); Srinivas Rajagopal, Marlvern, PA (US); Michael Mulqueen, West Chester, PA (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 09/882,257

(22) Filed: Jun. 18, 2001

Related U.S. Application Data
(60) Provisional application No. 60/212,124, filed on Jun. 16, 2000.

(51) Int. Cl. G06F 17/60

(52) U.S. Cl. 705/7

(57) ABSTRACT

Disclosed herein is a transport manager and related method for determining an optimal, cost-minimizing set of product transportation decisions based upon expected transportation costs. Additionally, disclosed herein is an electronic execution and related method for tracking and controlling the delivery and/or pickup of products according to the optimal transportation plan and a payment manager and related method for forwarding payments and invoices for the transport of the products.

### CROSS REFERENCE TO RELATED APPLICATION

This application claims priority from U.S. Provisional Patent Application Ser. No. 60/212,124, filed Jun. 16, 2000, the disclosure of which is hereby incorporated by reference in its entirety.

### FIELD OF THE INVENTION

The present invention relates to a transport manager and related method for determining an optimal, cost-minimizing set of product transportation decisions based upon expected transportation costs. In addition, the invention further relates to an electronic transportation plan execution and freight payment managers and related method for tracking and controlling the delivery and/or pickup of products according to an optimized transportation plan as well as forwarding payments and invoices for the transport of the products.

### BACKGROUND OF THE INVENTION

Within the modern economy, the transportation of goods and products is increasingly critical to the success of an organization. For example, businesses that operate on the Internet typically must transport goods to customers with every order. For these Internet business, transportation is not merely a simple business function that must be managed, but rather a strategic function that influences revenue generation and customer satisfaction. More specifically, a business having relatively higher transportation costs and/or relatively slower or less reliable delivery of goods may be at a severe competitive disadvantage. Accordingly, many organizations devote a high level of logistic resources to managing the transportation of goods and products, and, depending on the industry, the management of transportation services may account for up to half of an organizations total logistics cost.

Organizations have traditionally relied on one or more workers, hereafter transportation planning managers, to make decisions related to the transportation of goods and services. The transportation planning managers typically decide when, where, and how to transport goods and products. For instance, the transportation planning managers may determine the method or combination of methods of transport, namely air, freight, truck, cargo ships, etc., based upon business needs and the costs for transportation. As part of this determination, the transportation planning managers may also need to decide routes and times for transportation. The transportation planning managers may further decide the optimal packaging configuration (e.g., a few larger packages versus numerous smaller packages). These decisions are based upon costs considerations as well as other business concerns such as the reliability and expediency of the transport. These and other factors in making transportation decisions are described in greater detail below.

FIG. 1 schematically depicts the overall problem encountered by companies as they attempt to solve their transportation planning needs. As seen in the figure, three counterbalancing forces come into play when a transportation planning manager 100 is attempting to make these decisions. The first force is represented by order information 101 that details the desires of clients 104 or the company's sales divisions 105 to ship goods. Typically, this information includes source and destination, timeframe for the shipment, the type of transport desired or needed, and the size and weight of the good. The second force is represented by the type of shipping or carrier services 102 that are made available by transportation carriers 106 such as common carriers and/or private fleets. The type of transportation services made available by carriers 106 varies according to the type of transport (e.g. refrigerated truckloads, open rail cars, etc.), the geographical areas (shipping lanes) serviced by the carrier, and the prices charged for each type within each lane. The last force is represented by constraints imposed by real life business factors 103, determined from a business's know-how regarding its own operations and limitations 107, that may rule out certain transportation solutions as not being possible or as not making business sense. These constraints can include time windows, capacity limitations of shipping distribution centers, preferred carriers and relative compatabilities of products from different orders for joint shipment. In order to achieve an optimal planning solution, a transportation planning manager 100 must balance these three forces to determine an optimal transportation plan 114 that specifies transportation routes (lanes) 109, carrier selections 110, equipment selections 112, stop-offs 108 at crossdocks or distribution centers, time schedules 111, and expected costs 113.

In the making of transportation decisions, current technology allows transportation planning managers to automatically determine transportation costs, thereby allowing transportation planning managers to make more informed transportation decisions. For example, U.S. Pat. No. 6,233,568 (the “'568 patent”) issued to Kara on May 15, 2001 provides a system and method for automatically providing shipping/transportation fees. In particular, the '568 patent discloses a system and method for dispensing postage or other authorization information electronically by using a portable processor containing a maximum amount of pre-authorized postage which can be applied to any piece of mail or other item. A plurality of carriers may utilize the portable processor to store and dispense credit value for authorization of various shipping services. Accordingly, transportation planning managers are presented with information regarding various shipping service providers fees and/or services associated with particular shipping/delivery types desired by the transportation planning managers. This helps them make informed choices as to a most preferable method of shipment.

Current technology also allows transportation planning managers to track the status of goods in transport in real time. Parcel and express carriers, such as Federal Express™, the United Parcel Service™ (UPS™) or DHL™, typically assign a unique parcel identification, known as an Air Bill number, to each delivery. This unique designation for each parcel is done by providing two-part forms to the transportation planning managers, each including a unique, pre-printed bar code corresponding to the Air Bill number. One part of a form is attached to the parcel, while the transportation planning managers retain the other part of the form. The parcel identification barcode on the parcel is then scanned at each stage of delivery to track the progress for the parcel. The barcode scanner communicates with a host computer to transmit the parcel ID to a host computer. The parcel ID and its location information are then transmitted by the host computer to one or more web servers, each including a database for storing a record of the parcel ID's scanned at each location. The transportation planning managers, by running a web browser, may link through the Internet to one of the service provider web servers, and thus the parcel status database table, by specifying a URL (a “universal resource locator” which is commonly known as a web page's address). The URL usually points to an HTML file that is transmitted to the transportation planning managers who are then prompted to enter the unique parcel ID. The parcel ID is transmitted to the service provider web server and used as search criteria by the service provider, which returns the current location of the parcel for display on the transportation planning managers' web browser. When using paper Air Bills, however, the transportation planning managers must manually record and retain the tracking numbers for later use in looking up the status of a particular package. Additionally, prior art systems suffer from the fact that the transportation planning manager must repeatedly re-access the URL to receive updates as to the status of a freight movement.

To further assist the transportation planning managers in managing the transportation of goods, it is further known for one or more carriers to automatically charge for shipping services. For example, U.S. Pat. No. 6,175,825 (the “'825 patent”) issued to Fruechtel on Jan. 16, 2001, provides a method for debiting shipping services on the basis of the respective transport service fee schedules of carriers, centrally accounting operations of the services of various carriers, and debiting of the transportation services individually or summed together. In the '825 patent, a user program is loaded into a modified postage meter machine that has a printer and a telecommunication unit, and at least one service fee table of a carrier being selectable therefrom. The weight or some other physical quantity of a shipment is entered the modified postage meter machine, and a service value is calculated therein in conjunction with the selected shipping parameters. The printer device of the modified postage meter machine prints out an identity ticket that contains the shipping parameters, at least including the shipping fee for the shipment. The information characterizing the shipment is stored in the modified postage meter machine and the implemented value identification of the shipment is transmitted via a telecommunication connection to a remote data center, either individually or summed. The data received in the data center are acquired, compiled and separately accounted for each carrier with an accounting program and an invoice is prepared at the data center and is communicated to the transportation planning managers for payment.

Despite these and other tools currently available to assist in managing the transportation of goods, the transportation planning managers may potentially make errors that result in non-optimal transportation decisions because of the complex nature of modern transportation planning and management. To assist the transportation planning managers, many organizations are increasingly relying on automated product transport management systems. However, the known automated product transport management systems generally suffer from numerous limitations including an inability to accurately and efficiently plan and manage complex freight movements.

A more ideal product transport management system would provide, inter alia, increased revenue, lower operating costs, and increased customer satisfaction. To achieve these and other goals, the more ideal product transport management system and method should substantially automate the execution of the shipping process on both domestic and international transportation. Specifically, the more ideal product transport management system should simultaneously consider and optimize the organization's entire shipping requirements organization-wide. Additionally, such a product transport management system should have the flexibility to simultaneously optimize inbound, outbound, and inter-facility freight movements to decrease transportation costs and increase customer satisfaction. Specifically, a product transport management system should allow an organization to collaborate directly with its vendors to optimize transportation throughout a supply chain. This functionality would also allow an organization to dynamically select crossdock and pool point locations (i.e., transportation hubs or through-points) based upon the organization's business requirements and costs. Furthermore, an ideal product transport management system should consider pooling orders into many multi-order sub-shipments from origin to destination, and should optimize each individual sub-shipment to take advantage of economies of scale and thus optimize the shipment of multiple orders simultaneously. Such an ideal product transport management system should be able to automatically recalibrate the in-process shipment and consider each through-point to make automatically the best service and cost decisions.

An ideal product transport management system may further allow organizations to interact more directly with the carriers through the Internet, an Intranet, or through another form of electronic communication (such as standards-based electronic data interchange, or “EDI”). In this way, organizations may automate transportation operations and may collaborate with carriers electronically and in real-time to improve customer service and to better optimize total transportation needs. For example, improved integration with common carriers facilitates continuous move opportunities in which the carrier completes a delivery at a first site, and is informed en route to the first site to proceed to a second site to pick up freight from the second site and deliver it to a third site.

Additionally, an ideal product transport management system having electronic communications with carriers could allow organizations to locate shipments in real-time and to update and trigger downstream electronic billing systems accordingly. This functionality additionally can permit the product transport management system to monitor the status of a shipment and to alert the organization of any irregularities, such as unexpected delays or lost shipments. In this way, the organization may take remedial actions as soon as possible. By automatically monitoring the performance of carriers, the product transport management system may also dynamically adjust future transportation decisions based on historical transportation data, such as unexpected costs or delays associated with certain routes or carriers. The product transport management system may then make improved transportation decisions in the future. Direct interaction with the carriers may further allow the product transport management system to receive transportation bills, pay these bills, and charge an appropriate client an appropriately allotted amount for the freight movement costs. The automation of the transportation payments and billing increases payment accuracy and reduces overall transportation costs.

### SUMMARY OF THE INVENTION

In response to the above-described and other needs, the present invention provides electronic shipping and transportation planning, execution and freight payment managers and related methods that are useful to decrease shipment cycle time and cost while increasing services available to an organization and its clients. A first embodiment of the present invention allows organizations to fully optimize transportation operations by facilitating the modeling and management of extremely detailed order requirements and business rules to identify the lowest-cost transportation solutions according to those order requirements and business rules. Additionally, a second embodiment of the present invention allows organizations to fully optimize transportation operations by facilitating the implementation and management of selected transportation solutions. Further, a third embodiment of the present invention allows organizations to fully optimize transportation operations by facilitating the management of freight movement costs by identifying carrier costs and charging an appropriate client an appropriately allotted amount for the carrier costs. Finally, a preferred embodiment of the present invention allows organizations to fully optimize transportation operations by integrating the management of planning if optimized freight movements, execution of planned freight movements, and payment and collection of costs for completed freight movements.

According to the first embodiment, the electronic shipping and transportation planning manager and related method of the present invention automatically process a large set of information pertaining to three primary areas: order information (source and destination, time frame, type of transport desired, etc.) detailing clients' desires to ship goods, carrier information (type of transport, prices, etc.) detailing what transportation services carriers are willing and capable to provide, and constraint information (time windows, capacity, business goals, etc.) which describe what solutions are not possible. This data processing produces one or more shipping solutions for each order wherein these solutions propose alternative freight movements, that include particular carriers and equipment, to perform the clients' shipping tasks. The costs for each of these proposed freight movements are calculated (or “rated”) to identify and select the lowest-cost solution for each order.

According to the second embodiment, the electronic shipping and transportation execution manager and related method of the present invention automatically tenders shipment requests to carriers and automates the monitoring of acceptances, also preferably transmitted electronically, from those carriers. Additionally in preferred embodiments of the present invention, the electronic execution manager receives electronic updates regarding the status and location of shipments and stores these in a central execution database. This status and location information can then be transmitted to customers, distribution centers and the like regarding planned, executed or en route freight movements. Additionally, in such preferred embodiments the information stored in this database can be used for external carrier performance tracking, private fleet performance tracking, and equipment tracking to improve the planning of future transportation solutions.

According to the third embodiment, the electronic shipping and transportation freight manager and related method of the present invention automatically authorizes payment and collection of costs for completed freight movements.

Preferred embodiments of the present invention are computer networks and related methods that facilitate the planning and management of the transportation of goods within a supply chain. Further preferred embodiments of the present invention substantially automate and integrate three key business activities as discussed above; the planning of freight movements between a initial pick-up location and a final drop-off location, the management and execution of those planned movements with both private carrier fleets and public carriers, and the accrual, accounting and subsequent payment of all shipping costs incurred.

In such preferred embodiments of the electronic transportation managers of the present invention, three separate yet integrated electronic managers, in the form of networked modules, perform one of each of the above-mentioned business activities. A route planning manager, in the form of a problem-solver module, uses a sophisticated load building algorithm as herein described to identify and compare possible alternative freight movements from various potential route and stop sequences, modes of transport, and carriers. The decision making rules and information the problem-solver uses to make optional decisions regarding pending transportation orders derives from business parameters that a transportation planning manager establishes for the system and from carrier availability and rate table information provided by external or fleet carriers. The information provided by the transportation manager may include, for example, policies or operational requirements that his/or particular company follows. Using all of this information, the problem-solver performs various planning decisions before reaching an optimal transportation plan. The problem-solver may consolidate various orders and shipments into transportation loads. Then, a determination is made for each load as to the best shipping mode (carrier, equipment type, route, etc.) and routes that meet delivery time requirements and other business constraints are built. Lowest-cost alternatives are then identified to make the planned freight movements. Throughout the above functions, the problem-solver generates the most efficient load consolidations and makes the least-costly carrier and private fleet assignments within the constraints imposed by the orders and the transportation planning manager.

Further, after the problem-solver planning solution is generated, the transportation manager can manually review and modify specific freight movements as necessary or desired, or alternatively can route the output of the problem-solver consisting of the specific freight movements into an electronic transportation solution execution.

The electronic execution manager automates the tendering of shipment requests to carriers and automates the monitoring of acceptances, also preferably transmitted electronically, from those carriers. Additionally in preferred embodiments of the present invention, the electronic execution manager receives electronic updates regarding the status and location of shipments and stores these in a central execution database. This status and location information can then be transmitted to customers, distribution centers and the like regarding planned, executed or en route freight movements. Additionally, in preferred embodiments the information stored in this database can be used for external carrier performance tracking, private fleet performance tracking, and equipment tracking to improve the planning of future transportation solutions.

The freight payment manager automatically accounts for the incurred carrier costs, allocates the costs to the proper orders, and authorizes payment or invoices for all executed freight movements.

Preferably, in any one of the embodiments of the present invention a front-end user interface permits a transportation planning manager to interact with one or more databases to define a plurality of decision making algorithms to customize electronic managers and leverage the expertise of the transportation planning manger regarding the organization. Additionally, the front-end user interface permits a transportation planning manager to review and modify files for each shipping order.

As will be readily appreciated by one of ordinary skill in the art, the transportation planning capabilities of the present invention can extend across an entire enterprise or alternatively can be used regionally for specific geographic areas of an enterprise. For example, transportation planning can be done centrally for all locations of a client's distribution chain or alternatively, locally at each plant or distribution center. Of course, use of the present invention can also be adapted to have a blended approach wherein planning is initially performed at a central location, but wherein local planners (instead of a central transportation manager), then have final review and approval over the transportation plan.

Additional features and advantages of the invention are set forth in the description that follows, and in part are apparent from the description, or may be learned by practice of the invention. The objectives and other advantages of the invention are realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings with like reference numbers representing corresponding parts throughout:

FIG. 1 is a schematic diagram depicting the various forces that must be considered by a transportation planning manager when selecting and scheduling freight movements to satisfy pending shipping orders;

FIG. 2 is a flow diagram depicting the overall process steps performed according to one preferred embodiment of the present invention;

FIG. 3 is a block diagram depicting the operational aspects and interactions of an electronic problem-solver module for selecting optimal freight movements according to preferred embodiments of the present invention;

FIG. 4 is a block diagram depicting the operational aspects and interactions of an electronic execution module for scheduling and monitoring planned freight movements according to preferred embodiments of the present invention;

FIG. 5 is a block diagram depicting the operational aspects and interactions of an electronic freight payment module and related method for forwarding payments and invoices for executed freight movements according to preferred embodiments of the present invention; and

FIGS. 6, 7 and 8 are flow diagrams depicting the overall process steps performed according to one preferred embodiment of the present invention.

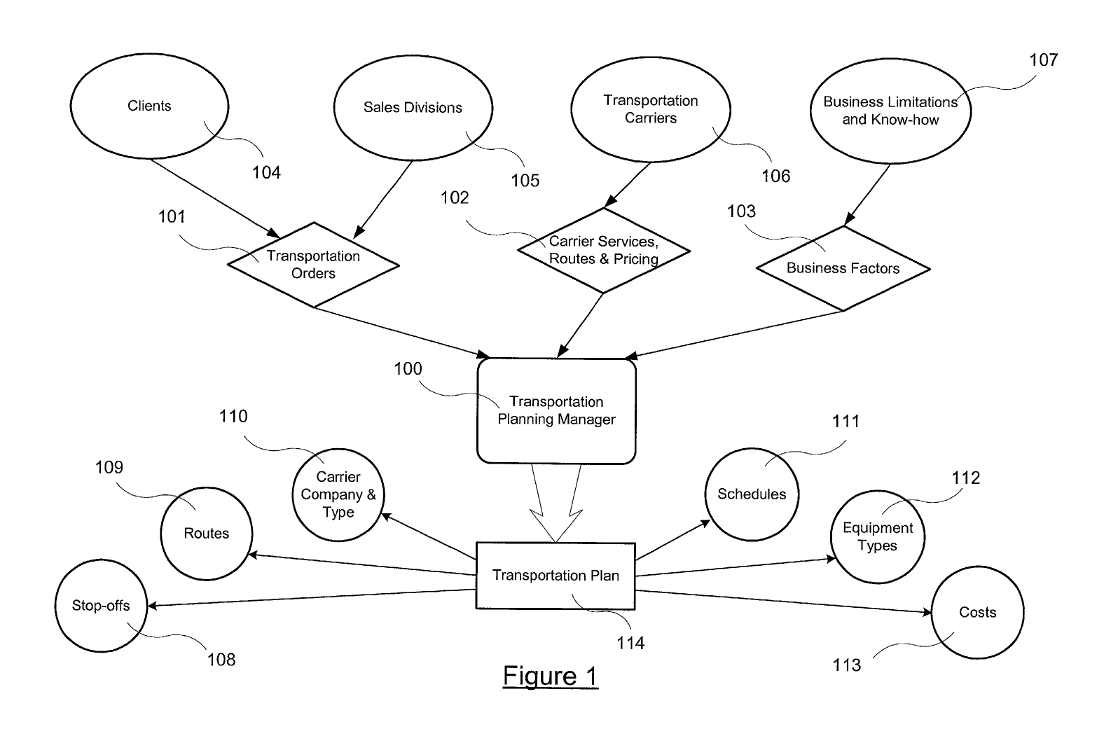

### DETAILED DESCRIPTION OF THE PREFERRED EMBODIMENTS

Reference is now made in detail to the preferred embodiment of the present invention, examples of which are illustrated in the accompanying drawings.

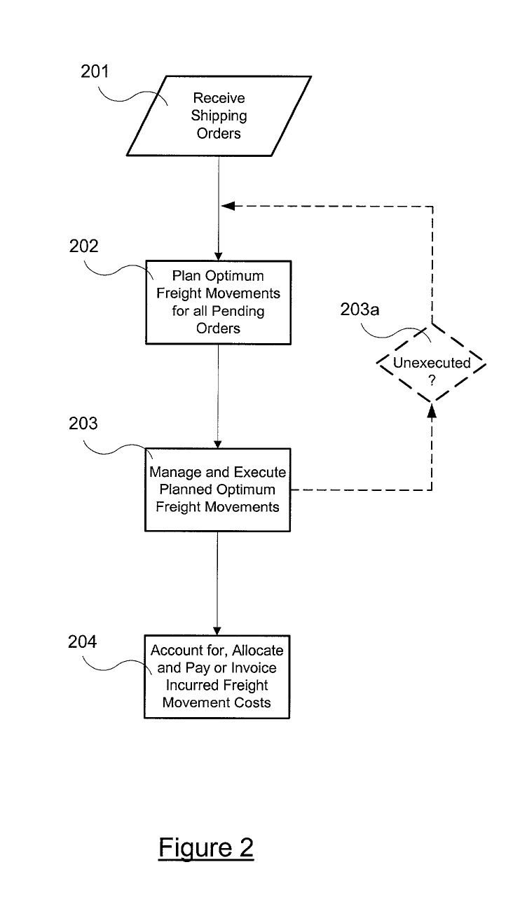

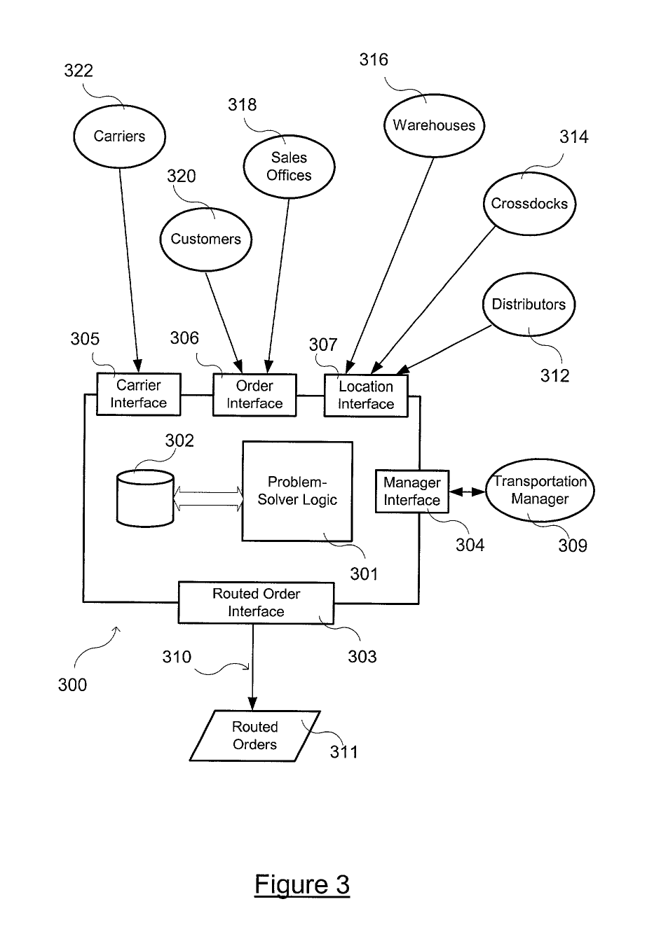

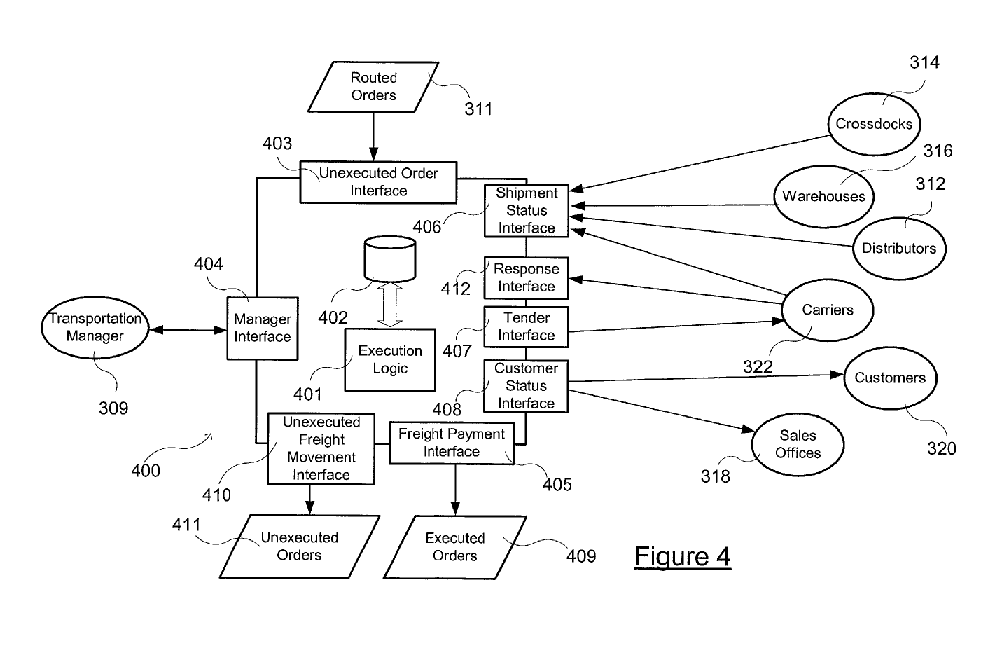

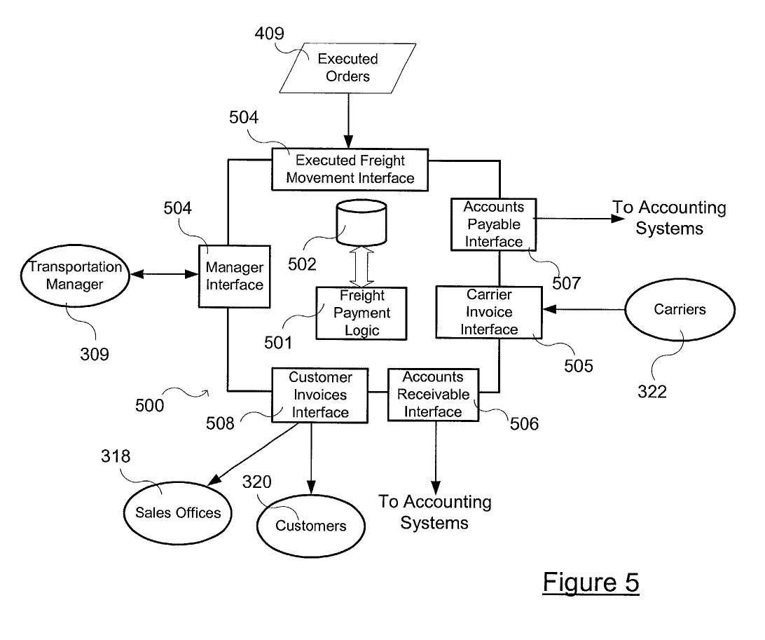

In the preferred embodiments of the electronic transportation managers of the present invention as shown in the figures, three separate yet integrated electronic managers, each manager in this preferred embodiment being embodied in the form of networked manager modules as depicted in FIGS. 3-5, perform the above-mentioned transportation activities in a manner as depicted by the flow diagram of FIG. 2. Specifically, referring to FIG. 2, after shipping orders are received 201, a first manager module, the problem-solver (“PS”) module 300 of FIG. 3, plans at step 202 optimal freight movements between a initial pick-up location and a final drop-off location. Next, at step 203, the optimal freight movements are planned in step 202 are executed and tracked by a second manager module, the execution (“EX”) module 400 of FIG. 4, so as to be executed using either private carrier fleets, public carriers or both. Finally, at step 204, a third manager module, the freight payment (“FP”) module 500 of FIG. 5, accounts for incurred costs for the executed freight movements, allocates the costs to orders received in step 201, and authorizes payment or invoices for all incurred freight movement costs that have been accounted for and allocated.

FIG. 2 also demonstrates that, optionally, if the planned optimum freight movements cannot be executed for any reasons (examples of such reasons provided below), such unexecuted orders can be directed back 203a into the first module such that they can be combined with newly received orders and be incorporated into a new optimal freight movement plan at step 202. Step 203a and the corresponding connecting arrows in FIG. 2 are shown in dashed lines to represent the optional nature of this flow.

As shown by the combination of FIGS. 3,4, and 5, the PS module 300, the EX module 400, and the FP module 500 preferably are electronically connected and operate integrally to handle a transportation order all the way from planning the route and carrier for a particular shipment to managing the shipment's delivery and invoicing the shipment costs for the order to the customer after shipment has been completed. In order to perform these functions optimally, all three modules require various interfaces and information flows as disclosed in FIGS. 3-5. The information flows and their associated interfaces will now be discussed in detail.

FIG. 3 schematically depicts the information flows and interfaces of the transportation problem-solver module 300 according to embodiments of the present invention. As shown in the figure, the PS module 300 receives information inputs from common carriers 322, customers 320, sales offices or affiliates 318, and warehouses 316, crossdocks 314, and distribution centers 312 (warehouses, crossdocks, and distribution centers collectively hereafter referred to as “locations”). The carrier interface 305 accepts information electronically from common carriers, preferably via EDI or the Web, pertaining to the types of transportation services offered by the carrier as well as the rates that they charge for these services. This information includes travel lanes, equipment types, and rates for those lanes and equipment types and is stored in the PS database 302 for use to calculate potential delivery solutions and to calculate the expected transportation costs for each route in the solutions to identify optimized solutions.

As shown in FIG. 3, a primary input into the problem-solver module 300 are the orders received from customers 320 and/or sales offices 318, via the order interface 306. Like carrier interface 305, the order interface 306 preferably accepts order information electronically, such as through the Web or EDI. Orders received through the order interface 306 have a single origin/destination pair. Additionally, each order includes all the information that the problem-solver needs to schedule it for pick-up and delivery. This information can be conceptualized as being divided into three parts which include header information, shipping units information, and routing information. The header information contains administrative data that, for example, identifies when and from where the order was received. The shipping units information identifies the type of product to be transported, the physical dimensions of the product (including length, width, and height), number of units and weight of each unit. The routing information provides detailed origin and destination locations as well as time windows for pickup and delivery.

A location interface 307, again preferably connected to the locations (312, 314 and 316) electronically, provides remote locations on a transportation network or supply chain with a direct mechanism to submit new and/or modified information pertaining to the ability of locations to handle orders, including whether they can stock new items, as well asthe current quantities of items in stock. The problem-solver logic 301 takes all these information streams and stores them in a central PS database 302 for later use whenever an optimization batch is run. Additionally, a manager interface 304 also allows a central transportation manager 309 or administrator to set process or business rules that are additionally stored in the database 302. Whenever a optimization batch is run in the problem-solver module 300, the current information regarding the carrier's orders locations and management rules stored in PS database 302 is accessed and utilized to compile various potential transportation delivery solutions with all orders having several alternative routes compiled therefor (if more than one route is physically possible). The problem-solver logic 301 then, using carrier rate tables stored in PS database 302, calculates an expected cost for each alternative route and selects the lowest cost route for each order as the proposed optimized solution. These proposed optimized solutions, known as “routed orders” 311, are sent via the routed order interface (“ROI”) 303 to down-stream systems (or alternatively directly to the transportation planning manager via manager interface 304 if he desires to have manual inputs on the proposed solutions). The primary output of the problem-solving module 300 is the routing order interface 303. The downstream systems according to preferred embodiments of the present invention include the execution module 400 of FIG. 4 and the freight payment module 500 of FIG. 5 as herein disclosed.

As described below, the problem-solver logic 301 employs an algorithm that can split orders, combine orders for shipping together, and then build, solve, and save an optimized transportation plan to PS database 302 and provide that proposed solution via the routed order interface 303 without active interaction from a transportation planner. Each batch run of the problem-solver module can be configured by the transportation planning manager 309 to run automatically. A batch can be triggered to run at a preset time or at the completion of a download of certain orders, or can be configured to run according to a preset schedule for specific horizon timelines. As will be readily appreciated by one of ordinary skill in the art, most problem-solver logic 301 batch runs will be triggered by the arrival of one or more new orders through the order interface 306. The fact that the problem-solver batch runs can be scheduled to occur at the happening of certain events, automatically at specified intervals, or only upon manual initiation by a transportation manager adds great flexibility to the present invention.

Although not shown in FIG. 3, the problem-solver module 300 could also be provided with a distance interface. As will be readily appreciated by one of ordinary skill in the art, the rates quoted by carriers often depend upon the distance for which the order has to be transported. To this end, therefore, the problem-solver logic 301 will need a manner for determining the distance between an origination and destination point quoted for each order. Therefore, the PS module 300 could utilize a distance interface for electronic communication with a distance calculating program such as MileMaker or PC*Miler.

The routed order interface 303 preferably outputs a flat file that details the proposed optimized transportation plan, consisting of one or more freight movements, developed by the problem-solver logic 301. This optimized transportation plan includes a detailed schedule of routes (at least one route for each order) including dispatch times, expected return times, and expected wait time occurrences at each leg of a delivery route. Additionally, the flat file includes chosen carriers for each shipment, the expected travel distances and times between stops, and the expected costs to be charged by each carrier. As discussed above, in alternative embodiments, the flat file provided by the routed order interface 303 could optionally be provided directly to a transportation manager for review (either in a hard copy format or through a GUI-based computerized interface through either the ROI 303 or the manager interface 304).

According to preferred embodiments of the present invention as depicted in FIGS. 3-5, however, the routed order interface 303 provides the optimized transportation plan file, comprising routed orders 311, directly to an execution module 400 via EX module's unexecuted order interface 403 as shown in FIG. 4. The routed order interface (“ROI”) 303 outputs information on freight movements for use by other systems. Each freight movement provided via the routed order interface is associated with a status code. Appendix 1 at the end of this application includes a table of status codes that can be appended to the database records of each order and/or freight movement in the PS database 302, the EX database 402 and the freight payment database 502 in the FP module 500.

The execution logic 401 stores the routed orders in an execution management database 402. As seen in FIG. 4, the execution module 400 is connected to carriers 322 via the tender interface 407. The execution module 400 uses the tender interface 407 to transmit tender offers (formal requests for shipping services) to the carrier(s) listed in the routed order interface flat file as having been selected by the problem-solver module 300. Preferably, each carrier utilized by the problem-solver module 300 is electronically connected to the execution module 400 through the tender interface 407 such that tender offers (and subsequent acceptances or declines as described below) can be sent electronically in annotated fashion through EDI, email or the Web. Alternatively, of course, means such as facsimile or telephone can be employed.

Once received, carriers can review tender offers and electronically provide an acceptance or decline of the tender offer to the execution module 400 via response interface 412. The execution module 400 can then re-route any declined orders back to the problem-solver module 300 as unexecuted orders 411 through unexecuted freight movement interface 410 such that the PS module may make a selection of a different carrier or transportation solution (this input not being explicitly shown in FIG. 3).

Additionally, the execution module 400 contains a shipment status interface 406 for use by the carriers 322 (both external and internal), warehouses 316, crossdocks 314 and distributors 312. The information transferred into the execution module 400 via shipment status interface 406 conveys information about shipments that are scheduled for delivery or en route including when the carrier expects the route to leave, when the route has left a distribution center, when the route has arrived at a particular crossdock or warehouse, as well as expected delays either at the carrier end or at the location end. The execution module 400 is able to use this shipment status information to provide updates to customers 320 or sales offices 318 via the customer status interface 408 as shown, or to trigger the accounting and invoicing features of the freight payment module 500 by sending it executed order information 409 via freight payment interface 405 as shown. It will be readily understood that truck-load (“TL”) shipments, less than truck-load (“LTL”) shipments, parcel shipments, express shipments and other shipment types (these shipment types being discussed in detail below) will not necessarily require the same functions from the execution module 400. Parcel and express shipments, for example, often do not employ carrier tender accept/decline transactions and thus would not utilize interfaces 407 and 412 in FIG. 4.

The tender interface 407 in EX module 400 outputs tender offers that contain most of the same information that is provided to the EX module 400 from the ROI 303 via the unexecuted order interface 403, but the tender offer files are organized in a linear structure such that they can be handled more easily by electronic commerce translation programs (such as EDI). Tender offer messages are sent to each carrier via the EX tender interface 407 whenever new unscheduled orders that require carrier tendering are received from the ROI 303 (assuming that such orders can be fulfilled by carriers that accept electronic tender offers). In cases wherein a particular selected carrier does not participate in electronic tenders, the EX module 400 could be adapted to send facsimile tender offers to such carriers automatically or to notify the transportation planning manager 309 whenever a new routed order is received for such a carrier. As described above, acceptances or declines of such tender offers can be received electronically via the response interface 412. In situations wherein carriers do not send responses (acceptances or declines) to tender offers electronically, such responses can be made in traditional manners (telephone, mail, facsimile, etc.) to the transportation planning manager and then entered by him manually via the manager interface 404.

The EX shipment status interface 406 as depicted in FIG. 4 delivers shipment status messages to the EX module 400 from carriers 322, distributors 312, warehouses 316, and crossdocks 314, etc., regarding a load or shipment while the load or shipment is en route. These status messages can include update information such as expected early or late arrivals, on time shipments received, or shipment completed and/or cancelled. When such messages are sent in real time from a carrier, these messages can be used to control alarm generation within the EX module 400. Such alarms, for example, can be used to send shipment status notifications to a transportation manager 309 via manager interface 404, or to sales offices 318 or to customers 320 via the customer status interface 408.

The execution management (“EX”) module 400 performs several managerial functions including automated carrier 322 notification of tender offers, receipt of carrier responses regarding acceptance of those tender offers, customer and location notification as to the status of loads in transit, tracking regarding the performance of carriers, alarm generation regarding delays of freight movements, and an output of executed orders 409 via freight payment interface 405. Similar to the ROI 303, the freight payment interface (“FPI”) outputs a flat file that identifies executed (i.e., completed) freight movements. The FPI output further includes information such as when the freight movements were completed, in addition to most of the information that was supplied to the EX module 300 via the ROI flat file. As with the ROI, in alternative embodiments of this preferred embodiment, the flat file outputted by the FPI 405 could optionally be provided directly to a transportation manager for review (either in a hard copy format or through a GUI-based computerized interface adapted to communicated with the EX module 400 through either the FPI 405 or the manager interface 404).

The freight payment module 500 as depicted in FIG. 5 receives this flat file of executed orders 409 from the EX module 400 via the executed freight movement interface 504 whenever particular freight movements have been completed. The freight payment (“FP”) logic 501 then processes invoices received, preferably electronically via carrier invoice interface 505, from the carriers 322 (if the carrier was a public carrier for hire) and allocates shipment costs to customers 320 or to sales offices 381 depending upon from where the a given order originated. The processed invoices are then compared against the costs predicted by the problem-solver module (these costs being stored the EX database 402 and passed to the FP module 500 for storage in the FP database 502 upon completion of the freight movement) and results of this comparison are stored for later analysis. Invoices can then be passed on to the customer 320 or sales office 318 (preferably electronically via customer invoices interface 508) for final bill collection.

Additionally, the FP module 500 includes an accounts payable interface 507 and accounts receivable interface 506. In this manner, the accounts payable and accounts receivable of the transportation manager's company is automatically updated by the freight payment module 500 when invoices are processed and costs allocated.

When connected to carriers electronically as shown in FIG. 5 (e.g., via EDI), the freight payment module 500 authorizes payment to carriers automatically for completed freight movements. The FP module generates payment vouchers based upon either expected shipment costs (as determined from carrier rate tables by the PS module), carrier invoices, or delivery notices. These vouchers are then sent to an accounts payable system (not shown) through the accounts payable interface 507 as shown in FIG. 5. The FP module, of course, can also be easily adapted to accept completed payment information in return from accounts payable and accounts receivable systems (not shown) to update records in the FP database 502. Additionally, invoices for allocated freight movement costs can be sent via customer invoices interface 508 to customers 320 and sales offices 318 (to request payment for charges invoiced by the carriers) while accounts receivable records can be automatically sent to an accounting system via accounts receivable interface 506.

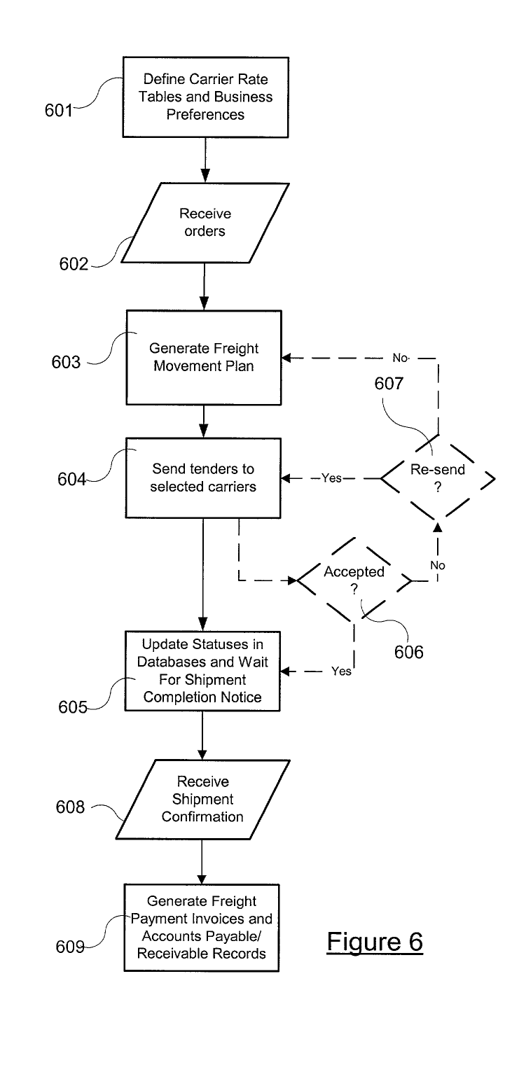

The problem-solver logic 301, execution logic 401 and freight payment logic 501 will now be discussed in detail with respect to the flow diagrams of FIGS. 6-8. FIG. 6 is a flow diagram depicting the overall process steps performed according to a preferred embodiment of the present invention wherein the problem-solver module 300, the execution module 400 and the freight payment module 500 are arranged such that they form integrated network that can handle transportation management completely from the point of collecting rate table information from carriers and receiving orders from customers all the way up to issuing invoices to those clients when the orders have been fulfilled. As will become apparent from the discussion to follow, the steps of FIG. 6 are performed by the three above-described modules in a cooperative manner such that the PS module performs the actions required by steps 601-603, the EX module performs the actions required by steps 604-608, and the FP module performs the actions required by step 609.

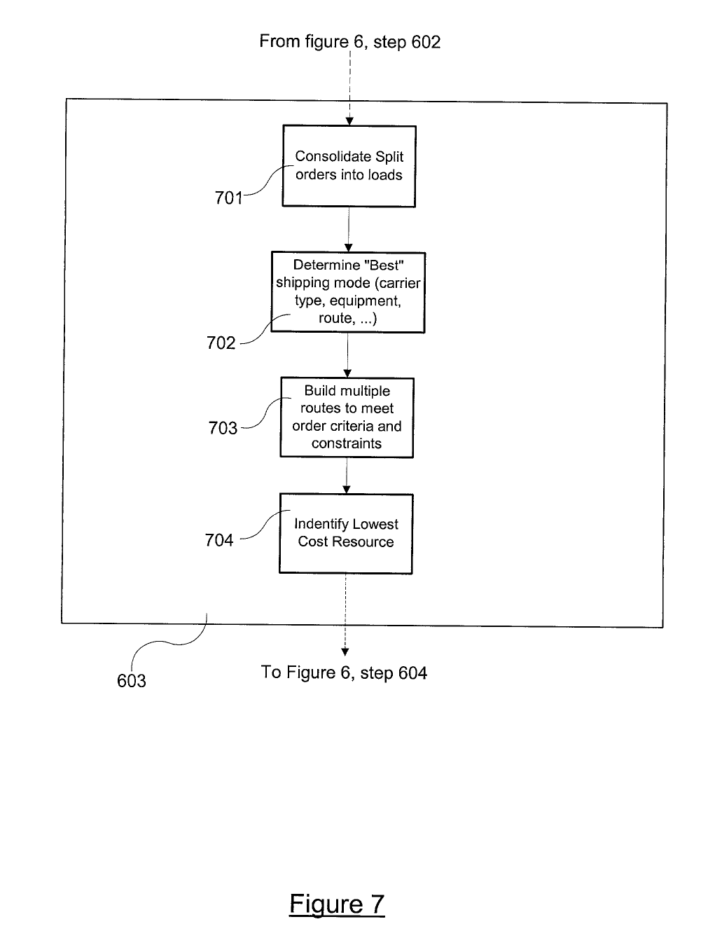

As discussed generally above, the PS logic 301 takes various inputs into account in order to route and then provide cost ratings for various shipments at a given time. The problem-solver logic 301 of this preferred embodiment is adapted to leverage a user's knowledge of his or her transportation network rather than sequentially consider every possible route through a network as a solution for a particular order. Referring to FIG. 6, it is shown that the decision making rules and information the problem-solver logic uses to make optimal decisions regarding pending transportation orders are first defined at step 601 before a batch process is run by the problem-solver logic (that is, before any orders are ever received at step 602). The rules and information used by the problem-solver logic are a combination of templates and business parameters that a transportation planning manager establishes for the system and carrier service availability and rate table information (as discussed below) provided by external or fleet carriers. Transportation planning managers can, for example, by using the manager interface 404, define route planning rules, create templates that define legs for multiple leg routes and multiple mode routes (the entering of such templates, while done at step 601 prior to a batch run, will be discussed in detail below with respect to step 603, FIG. 7, and specifically with respect to multi-leg routes) or enter constraints to enforce policies or operational requirements that his particular company follows. All of this information is taken into account once the problem-solver begins to compile optimal transportation plans.

The PS logic according to embodiments of the present invention routes every suitable freight movement that could fulfil a transportation order within the rules set by the transportation planning manager. A particularly advantageous feature of the present invention involves the use of priority routing rules in the PS database that enable a transportation planning manager to influence the creation of loads and freight movements when lowest cost is not the most important consideration. Typically, after it identifies all potential suitable freight movements for each order, the PS logic identifies the lowest cost transportation solution. This solution, however, is bound by a set of customer service requirements and the priority routing rules that limit the field of possible transportation solutions. These routing rules can include: time windows indicating hours across the day for which pickup and delivery are available, carrier ratings indicating levels of expected performance by the carriers, order pickup and delivery sequences for multiple leg routes, compatible equipment types to service a particular location, federal and/or state regulations governing the transportation of certain material types (for example, hazardous material), etc.

Additionally, at step 601 the PS logic accepts rates for each carrier type, and each carrier within the carrier type. These rates are specified in a plurality of tables which are stored in the PS database 402 for use during batch runs. Such rate tables are stored therein for each carrier type, including truckload (“TL”), less than truckload (“LTL”), parcel and package carriers (both being herein referred to as “package carriers”), railroads, air, and sea transporters. Disclosure that is presented below with respect to the rating aspect of the PS module (sub-step 704 of FIG. 7) will discuss sample shipment cost rating tables for some of the carrier types listed above.

Batch applications such as are employed by the PS module are powerful in the sense that they can look at an entire complex problem, such as a large group of orders available to be shipped through a large number of possible carriers, and create a one-time low-cost solution. At some point, however, the transportation planning manager must decide when the PS logic 301 will begin a batch process to generate freight movement plans (step 603 of FIG. 6). Typically, the PS module will be configured such that a batch process will begin to run once a certain amount of orders are received 602. Alternatively, of course, the transportation planning manager could elect to manually initiate step 603.

When the PS logic begins its batch run at step 603 to generate an optimal freight movement plan (for all orders received since its last batch run) it performs several sub-steps which are detailed in FIG. 7 as a separate flow diagram. FIG. 7 demonstrates that step 603 of FIG. 6 can be more specifically described as four sequential sub-steps. The sub-steps that comprise a batch run of the PS logic according to preferred embodiments of the present invention will now be discussed with respect to FIG. 7. Detailed discussion of the remaining steps of FIG. 6 will be resumed later below after complete discussion of FIG. 7.

During a batch run, the problem-solver logic 301 first consolidates various orders and shipments into transportation loads at sub-step 701. Then, a determination is made at sub-step 702 for each load as to the best shipping mode (carrier, equipment type, route, etc.) for transporting the load. In order to achieve the above planning sub-steps, the system uses various types of information including data detailing the required freight movements, tables itemizing resource availability and cost, operational requirements of the industry, and general company rules and policies entered by the company's transportation planning manager. After modes have been selected, multiple alternative freight movements that meet delivery time requirements and other business constraints are built for each load at sub-step 703. The lowest-cost alternative freight movement for shipping each load is then identified at sub-step 704 and selected for inclusion in the optimal transportation plan. Throughout the above functions, the problem-solver generates the most efficient load consolidations and makes the least-costly carrier and private fleet assignments within the constraints imposed by the orders and the transportation planning manager.

In all sub-steps of FIG. 7, the problem-solver module of the present invention is adapted to leverage a user's knowledge of his or her transportation network rather than look at every possible route through a network. Transportation planning managers can, by defining leg-based account profiles (at step 601 of FIG. 6 prior to a batch run), set planning rules and specify legs for multi-leg routes and multi-modal routes. For example, a transportation manager can utilize his knowledge of his company's distribution network by specifying that a particular batch sequence be set up as a three-leg route wherein the middle leg is performed via rail with a specific rail carrier.

Whenever feasible, at sub-step 703 the PS logic will attempt for each load to construct routes according to multiple leg routes on a particular lane, then construct two-leg routes through any through-point setup by the planning rules, and, finally, construct a direct shipment. In addition to designating multi-leg trips, through-points can be defined such that any order on an appropriate lane will first be routed there-through, if possible. In the case of both though-points and multiple leg routes, application of these planning rules by the PS logic processes depicted at step 703 is performed only on a lane by lane basis (i.e., a through-point or multiple leg route only applies to one or more applicable lanes).

More specifically, according to embodiments of the present invention as described above, the PS logic at sub-step 701 considers combining various separate orders in a given batch for delivery due to those orders having a common shipping and/or delivery location. Certain shipping locations within the PS database can be designated as belonging to a shipping complex. This is typically the case when a large company has multiple distribution centers or plant locations but wishes to have its orders delivered to a single location to provide price consolidation and order consolidation. Thus, any order designated as going to a particular plant location of such a company would be combined with any other orders designated as going to any other location belonging to that company. In this manner, orders that are good candidates for consolidation are more easily identified and economies of scale are advantageously employed.

Similarly, the PS module automatically splits large orders into one or more sub-orders when those large orders are too large to be shipped together (such as because the order is too large to fit in a single trailer on a single TL or LTL shipment). Any freight movements resulting from split orders will be tagged as split orders when they are sent through the ROI to downstream systems such as the EX. The EX then, therefore, can combine the two freight movements into a single order record for purposes of tracking and tracing, as can the freight payment module for purposes of freight movement charges allocation and invoicing.

Many carrier types are available in the transportation industry. At sub-step 702, the PS logic 301 determines the best shipping mode for a given order. This determination depends upon many factors including the kind of good, the size/weight of the freight, and desired delivery timelines. Typically, large and/or heavy materials with relatively remote delivery deadlines can be sent either on commercial or private fleet truck loads (“TL”) while medium size or medium weight freight movements can be accomplished using commercial or private truck carriers in a less than truck load (“LTL”) scheduling. Large to medium weight or size freight movements can also be accomplished over land via rail transportation or even air transportation. Large to medium size and weight freight movements, particularly for transcontinental shipments, can also be accomplished via sea barge.

Smaller size and weight packages are typically shipped either via standard parcel service (such as the U.S. Postal Service, UPS, etc.) or via express or overnight service (for example Federal Express). Generally speaking, transportation rates of parcel, express and overnight service packages increases with speed of delivery (overnight vs. three-day) and size and/or weight of the package. The timeline for delivery of an order is one of the major factors considered by the PS logic at sub-step 702 when considering whether to use package carriers.

Additionally, one or more carrier types are often employed in combination to form an intermodal carrier route. A typical example would be for a large-weight shipment to be scheduled to run via TL carrier from the distribution center to a sea port and then transfer from the sea port oversea via transatlantic barge to Great Britain.

Disclosure below with respect to the rating aspect of the PS logic (sub-step 704 of FIG. 7) will disclose sample shipment cost rating tables for some of the above carrier types to help further illuminate the differences between the above carrier types and thus indicate when one carrier type may be more beneficial for use than another carrier type for a particular category of order requests.

For each order being processed in a particular PS batch, the PS module at sub-step 703 performs a first cut that determines which carriers (in the mode or modes selected at sub-step 702) are possible to service the particular order. Sub-step 703 essentially takes the resources identified in sub-step 702 and searches the services offered by carriers for matches within relevant lanes. For example, a large freight order that needed to be moved via truck load from New York to Los Angeles could not use a TL carrier that only operated in the southeast United States. In performing this first cut, the PS module considers: time windows (such as by hour of the day across the week) that the carrier is available for pickup and delivery, order, pick-up and delivery time windows, order pick up and delivery sequence (such as where a carrier is being utilized for a multi-leg route), whether the carrier has compatible equipment to service a particular order or location (such as where the carrier needs a refrigerated car to transport perishable food goods), overlap of geographic service areas and proposed transport route, and order grouping for compatibility and/or incompatibility purposes.

Additionally, at sub-step 702 the PS logic considers combining LTL and package shipments into trailer size (i.e., TL) loads to increase the efficiency of the trailer loading process in the warehouse. The shipments are grouped by carrier by breakbulk, which is a location associated with lanes. Typically, the trailer building PS logic is applied after the PS module has completed an initial assignment of of orders to the standard carrier approaches (TL, LTL, package, etc.). Outbound shipments that were created by the problem-solver with these standard carrier approaches then are brought into this trailer building PS logic. In these instances, the shipments already have proposed carriers. The shipments that are assigned to LTL and package carriers are grouped by carrier, origin, and breakbulk. If there is a compatible trailer type available, the shipments with the same carrier, origin, and breakbulk will be placed onto the trailer if they exceed the breakbulk's minimum quantities. Additionally, it should be understood that all shipments combined by the trailer building PS logic must have overlapping time windows. Additionally, the commodities for the shipments that are placed on combined trailers must be compatible with each other and compatible with the trailer type.

For freight movements comprising such built trailer loads, the early depart time for the trailer is set to the latest of the early depart times for the shipments on the trailer and the late depart time for the trailer is set to the earliest of the late depart times for the shipments on the trailer. The combined trailer built through this process is then submitted as a proposed solution to the rating algorithms of the PS module. If the combined shipment offers a cost savings over the individual shipments, the combined shipment is sent through the POI and the individual shipments are discarded and vice versa.

As described generally above, whenever the PS module builds a trip at sub-step 703 for a batch of specific orders, it attempts to route the orders at least once in each of the following ways: directly to their destinations, through a single through-point (such as a crossdock or distributor), and via multiple through-points (referred to herein as multiple leg routes or “MLR”). The PS then generates a cost rating for each trip and determines which routing method produces the best cost solution at sub-step 704.

Each order received in the PS module preferably includes a package type that indicates what method is used for storing the commodity or product that is being shipped. These package types can include palates, slip sheets, or floor loads (i.e., loose boxes). This package type information can be used down the line by the problem-solver in sub-step 703 in determining applicable loading methods. As will be readily appreciated by one of ordinary skill in the art, a package type will necessarily determine whether or not certain loading methods can be used to load or unload a particular carrier at a stop. For example, forklifts can be used to move palates and thus decrease loading and unloading time while floor loads cannot be moved easily by forklifts. Therefore, whenever the PS module encounters floor load package types for a particular order, it knows that it will take longer to load or unload that particular order at a stop and thus make routing schedules accordingly during sub-step 703.

A multi-leg route (“MLR”) leg proposal is associated with a shipping lane by the PS and represents a particular route for all orders in that lane that the transportation planning manager expects to be particularly efficient for his organization's shipping needs. A multi-leg route freight movement (or portion thereof) specifies a sequence of through points (crossdocks) that a particular freight movement must flow through. The transportation planing manager can associate an account profile with each leg if necessary (such as during step 601 of FIG. 6). Prior art systems and methods for transportation planning often allow an order to traverse through a single through-point only on its way from source to destination. The present invention overcomes this limitation via the use of an organization's internal knowledge with respect to its supply chain.

In order to process MLRs efficiently, the PS logic only utilizes such proposed MLR routes stored in the PS database as opposed to considering every possible multiple through-point route for every load. These proposed MLR routes are entered by the transportation planning manager prior to the running of a particular PS module batch and are based upon the transportation planning manager's knowledge of his or her particular supply chain. Therefore, whenever the PS module runs, the following choices of routes will be considered for every possible freight delivery: an MLR for each possible combination of proposed MLR legs within a particular order's lane, a one-stop route through any of the PS defined regular through points set up on the order's lane, and a direct route from the origination point to the destination point.

Suppose there are three orders that originate from three separate source points in Malaysia with the orders destined for two different destination points within the United States. The first and second orders from Malaysia are heading to Chandler, Ariz. and the third order from Malaysia is headed to Hillsboro, Oreg. The MLR legs corresponding to each lane are set up by the transportation planning manager during configuration. In this particular build, one MLR proposed route containing the three crossdocks PEN (the Malaysian airport), LAX (the port of entry into the United States at Los Angeles) and PDX (the airport in Portland, Oreg.) is set up before the PS batch run on a lane from the third of Malaysian origin point to Hillsboro, Oreg.

A second MLR proposed route is entered specifying a lane including the first and second Malaysian source points that are to be delivered to a single location in Chandler, Ariz. This second MLR proposed route contains PEN, LAX and PHX (the airport in Phoenix) as the intermediate through points.

When the above orders are considered in the problem-solver module during a batch, an initial decision is made by the PS on which route is best for each order. All eligible MLRs proposed by the transportation planning manager are compiled by the PS logic during this sub-step of a batch run along with any potential through point trips (comprising a single stop) and direct routes for each order from origination to destination point. Estimated costs for each route are used to make the decision after all potential freight movement paths have been identified. While some savings are realized through the consolidation of one or more orders together, it should be understood that the cost calculations for an MLR by the PS module (as well as TL, LTL, air, rail, and sea freight movements) are essentially estimates since the full impact of multi-stop trips and result in accessorial charges is unpredictable. Having made an initial determination about the best route, the PS module puts together all legs of a subsequent MLR. This sequential leg building procedure allows for all bundling opportunities to be accounted for. For example, in the above scenario all three orders will be built onto the same trip on the leg spanning PEN and LAX. Additionally, the two trips originating from the first and second locations in Malaysia that both are traveling to the location in Arizona can both be routed together from LAX to PHX and from PHX to their final destination via truckload. Bundling freight movements together in this manner typically results in reduced costs due to advantages from economics of scale.

As indicated above, the PS module's manager interface is adapted to allow a transportation planning manager to define, prior to PS batch runs, potential MLR legs. According to preferred embodiments, this is accomplished using MLR templates. A MLR template basically comprises an input mechanism (such as in the form of computer form or checklist) that enables a transportation planing manager to suggest a sequence of through-points (like “crossdocks” which can be defined generally as an intermediate freight consolidation point) that are associated with a given transportation lane (thus leveraging the knowledge and experience of the organization). The MLR templates are stored in the PS database and, when taken together by the PS logic during a batch run, serve as a series of building blocks around which the PS logic will attempt to construct MLRs for any freight movement in that lane. In other words, when a MLR template is entered into the PS database, it is considered by the PS module as a possible route through which to ship orders that can pass through that lane. Therefore, instead of considering all possible combinations of MLRs, the PS logic simply tries to fit the orders for the current batch first into the legs as proposed by the MLR templates, and then it attempts to consolidate the remainder of the legs of the shipment at a later time (either automatically or manually with the assistance of a transportation planning manager).

Capacity limits for a proposed MLR can also be defined within a MLR template by the transportation planning manager. When capacity limits are assigned to an MLR template, they override other limits that may have been defined for crossdock locations used in the template. (However, when orders that are not part of an MLR trip are routed through the same crossdock location, the crossdock's own capacity limits, if any, apply.)

MLR capacity limits can serve as a powerful mechanism for influencing how the PS logic decides to route orders via a specific MLR trip. In preferred embodiments of the present invention, three different capacity thresholds can be set (thus defining four ranges) within each MLR template; a lower capacity MLR threshold below which all orders are routed through the MLR's through-points, an upper capacity MLR threshold above which no orders are ship via the MLR's through-points, and an intermediate capacity MLR threshold that divides the area between the upper and lower capacity MLR thresholds into upper-middle and lower-middle regions. Each of these four regions designates a different treatment by the PS logic during any running of a particular batch process that considers MLRs on the particular lane.

If orders that fall into a lane, serviced by a given MLR template, have capacities that fall below the lower capacity MLR threshold, these orders will be claimed, so to speak, by this MLR during the PS logic's trip building process. However, the same orders may fall below this limit for other defined MLRs as well (and for other types of through-points, like crossdocks) and may therefore be claimed by multiple MLRs and through-points. To route these orders, the PS logic ultimately routes all of them and then makes a cost-based decision between the MLRs and other through-points that claim the bundle of orders at sub-step 704 as discussed below.

This behavior in the lowest region is rule-based, which means that when orders fall below this capacity limit, and are claimed by an MLR (or single through-point), the problem-solver logic 301 rules out the direct routing option for these orders even if it may lead to a lower cost trip. Thus, a direct route would not be compiled and sent to sub-step 704 for a cost calculation and comparison.

The intermediate capacity limit separates the area between the upper and lower capacity limits into two middle capacity ranges, the upper-middle and lower-middle ranges. The problem-solver logic treats orders differently depending on whether their capacities fall above or below this limit. If order capacity falls within the lower-middle range, the problem-solver will make a completely cost-based decision about how to route these orders. Thus, orders falling within an MLR's lane (and having a capacity in the lower-middle range) will be routed on a trip created from a given MLR template only if it represents the best cost trip for the orders. To encourage cost-based decision making, capacity limits can be set by the transportation planning manager such that this range is the widest. This purely cost-based behavior will be the default if no capacity limits are set for a given MLR template.

If order capacity falls within the upper-middle range, the problem-solver logic will make an initial decision not to route the orders on a trip created from a given MLR template. This initial behavior is rule-based, meaning that, even when this MLR represents the best cost trip for certain orders, they will not be routed through it if their capacity falls above this limit. However, later in the problem-solver's trip building process, routing options for orders that fall into this capacity range are re-evaluated. The PS logic, if so configured by the transportation planning manager, could then consider whether alternate routing options could yield lower cost trips for such orders. It is significant to note that at this point, other trips and MLRs, which did yet exist the first time around, can now be considered. Final routing decisions are ultimately cost-based. The overall effect of the intermediate capacity limit is that as its value is moved closer to the lower limit, the likelihood decreases that orders will be routed through this MLR.

If orders that fall into a lane, serviced by a given MLR template, have capacities that are above the upper capacity limit, the MLR template (and the through-points it defines) will not be considered an option for these orders. Like with orders falling below the lower capacity limit, behavior in the area above the upper capacity limit is strictly rule-based. It effectively requires that even when a trip created from this MLR template might yield the best cost trip for certain orders, if their capacity is more than the limit set here, they will not be routed through MLR. The PS logic will, however, still consider other MLR templates, other through-points, and the direct routing option.

In some cases, setting capacity limits can reduce the amount of time the PS takes to schedule a group of orders. For example, if it makes good business sense to avoid sending orders weighing more than 50,000 pounds through an MLR, set the upper capacity limit for an MLR should be set to 50,000 pounds. When the problem-solver considers an order that large, it will not spend any time attempting to schedule the order on the MLR.

Even more powerful is the potential that capacity limits provide for helping the PS logic choose MLR templates with specific attributes. Let's say, for example, on a given lane, you set up one template that uses air transportation for its longest leg, and other templates that use ground transportation only. As will be readily appreciated by one skilled in the art, a transportation planning manager can use capacity limits to ensure that only relatively small orders are routed via the MLR with the air transportation leg.

For example, if a transportation planning manager wished to use the capacity limits for an MLR template so that it will be used to create trips only for orders with a capacity of less than 150 pounds he could simply set the lower limit at 50 pounds, the intermediate limit at 100 pound, and the upper limit at 150 pounds. This aspect of MLR capacity limits allows the PS logic to choose between different MLRs on the same lane, and between an MLR and other routing options.

Assuming the PS module 300 is provided with a plurality of through-points or crossdocks, a MLR could be built dynamically by the PS module during each batch by considering every available combination of crossdocks to get the shipment from its origin to its destination. As the order batches become more complex (involve more shipments going to more locations), forcing the PS module to try out every possible combination would increase its run time to unacceptable levels even using extremely sophisticated and expensive hardware. The present invention alleviates the above-referenced computational problem by utilizing MLR leg proposals provided by the user. These proposed legs leverage the company's own business knowledge to influence how the PS logic builds multi-leg trips. Therefore, instead of starting the procedure of formulating MLR shipments from scratch each time a new batch of orders is routed to the problem-solver, the problem-solver uses the proposed legs of the route to help compile feasible and cost-effective MLR trips.

Additionally, at sub-step 703 the continuous moves PS logic enables the PS module to create what are known in the transportation industry as “continuous move tours.” A continuous move tour defines a set of truckload trips (or loads) that are joined together to form one continuous route (or continuous move) using the same truck. It should be understood that two or more trips can be linked by empty legs wherein the truck has no cargo, however, to be profitable the number and length of the empty legs need to be minimized. TL and LTL carriers often provide discounts whenever shipments are consolidated into a continuous move tour due to the high vehicle and driver utilization they achieve.

The PS logic can add a new trip to the end of an existing trip or tour (the PS logic recognizing when one freight movement ends and where another begins) or can combine two freight movement trips via truckload created during an earlier PS module run to form a new continuous move tour. Preferably, two trips created by the PS module are combined together to form a continuous move tour if the continuous move would cost less than sending both trips separately and via different carriers and if the tour can be completed feasibly.

Another long-standing issue with respect to transportation management is that transportation managers or prior art systems and methods are unable to take into account location limitations that exist outside of the transportation managers enterprise or the carrier fees. A typical example of such a location limitation would be where a distribution center has only a limited number of truck doors or other related throughput constraints stemming from limited work schedules on weekends. As such, prior art systems and methods for transportation management would have a bias toward shipping freight movements at their earliest, best start time. That is, when multiple TL trip start-times will result in the same cost for a trip, the earliest of these times was typically chosen as the start time for each freight movement. This rule often resulted in many freight movements being scheduled for a service time simultaneously at a single location (such as the distribution center). Since these locations typically have restrictions on the number of freight vehicles they can handle simultaneously, as well as how much loading or unloading work they can accomplish within a given amount of time (such as due to workload constraints), it is often desired that service time for trips at a location be staggered. Furthermore, in the case of a depot location or crossdock that is a stop station for private fleet carriers, it is often desirable to stagger trip start-times to closely follow truck driver start-times and shifts. Therefore, the present invention incorporates location constraints that enable the staggering of location service times to solve such problems.

According to the present invention, a set of time windows are defined with respect to each crossdock and/or warehouse and stored in the PS database. Each of these location constraints (“LC”) time windows will have associated activities constraints. The activity constraints can be represented in a variety of ways including a number of trucks that can be serviced in a given amount of time, a number of order quantity measurements (i.e. weight, cube, pieces, pallets, etc.) that can be handled in a given amount of time, and/or a maximum weight size per truck order that can be handled. Additionally, the present invention allows such LC windows to be designated as either hard or soft to indicate that the activity constraints are to be strictly enforced or are to result in a cost penalty within the problem-solver logic, respectively. If the constraints are soft, the cost penalty will be specified in a cost per excessive use or unit and incorporated into the selection of the route and/or solution by the PS logic during batch run sub-step 704.

According to embodiments of the present invention, the transportation planning manager can define location constraints using LC templates (similar in efect and operation to MLR templates as described above) that take into account limitations that exist with respect to crossdocks, through points, distribution centers and the like. These limitations can include the physical limitations of the center (how many forklifts are available) or the work schedules of the workers at that particular location. These LCs are then stored in the PS database and used by the PS module during batch runs at sub-step 703 of the PS logic.

As mentioned above, within an LC window, constraints can be designated as hard or soft to indicate whether the activity constraints are to be strictly enforced by the PS module or are to result in a cost penalty when the PS logic begins calculation of relative location-constrained rates of possible routes. If the constraints are designated as soft, the cost penalty will be specified in a cost per excessive unit. In particular, location constraints are used by the PS logic with respect to TL and LTL carriers. A discussion of decision algorithm employed by the PS logic when two or more proposed routes are completing for location-constrained resources is provided in Appendix B below.

In sub-step 703, the PS logic also considers what is known in the industry as multi-shifting. Any resource utilized by the PS logic is identified in the PS database by carrier, lane and equipment type. For example, a particular resource (truck) belongs to the XYZ Trucking Corporation, is a 48 foot flatbed truck, and is designated to operate within the Pennsylvania to Maryland lane. In many prior art transportation management systems, once a particular resource is assigned to a trip that resource is exhausted for the rest of the planning horizon (such as the rest of the day) and cannot be reused for another trip on later runs of the transportation management system. As a result, if a particular resource receives a short trip that does not exhaust its usefulness for a whole day, that resource will remain unoccupied for the remaining portion of the planning horizon.

To eliminate this under-utilization, the PS logic assigns a time window to each calculated trip that represents the entire time that that resource will be unavailable for further use. In this manner, the same 48 foot truck can service delivery that lasts from 6:30 a.m. until 11:30 a.m. and a second delivery that lasts from 1:00 p.m. to 8:00 p.m. To ensure that the time windows are properly set, the transportation planning manager and the carriers are able to specify a fixed down time between trips within given lanes and the PS calculates estimated route times for TL and LTL freight movements.

Batch applications such as are employed by the PS module are powerful in the sense that they can look at an entire complex problem, such as a large group of orders available to be shipped through a large number of possible carriers, and create a one-time low-cost solution. Batch applications, however, are inherently limited in their ability to provide continuous optimization over time. At some point, the users of the batch application need to start off the process, which will optimize all information that it has at that particular point and time. Unfortunately, the enterprise using the optimization engine is often still allowing changes to the problem components (a.k.a. orders or carrier availability) that were just optimized. In the field of transportation management, these changes include order deletions, modifications and additions that, if known at the time of optimization, would have resulted in a much different solution. While an enterprise can limit the ill effects from changes and deletions by enforcing strict business process rules around order changes and cut-off times, such strict business process rules often conflict with the drive for total customer satisfaction. Thus, it is desirable to have the ability to update and/or correct order information after a batch process, i.e., a PS module optimization bath as described above, has been run.

Commonly, situations will occur where some of the orders in a current PS batch (whose status are “N”, designating new un-routed orders) are going to a same destination from a same through point or origination point as some of the already existing freight movements that have been tendered by the EX (having a status “T”). (The database status codes employed in preferred embodiments of the present invention are itemized in Appendix A.) Whenever the PS module runs a batch, since tendered loads are not necessarily considered part of a batch because they are not “new” orders, rules may be set by the transportation planning manager where the PS module considers making any such overlapping new orders an “add on” to any compatible tendered existing trip. In this manner, a new freight tender would have to be sent via the EX module to the appropriate carrier.

Additionally, preferred embodiments of the present invention allows the PS logic at sub-step 703 to add to an already optimized route (in other words, it adds an order that would “tag along” with an already optimized route if that order was originating from and going to similar locations where the route provided through the routed order interface). As shown in FIG. 4, the EX module could re-route unexecuted freight movement orders 411 that had either been routed, tendered, accepted by carriers after tendering so long as those routes have not yet been dispatched. In this case, the problem-solver would use this existing freight movement and add the new order onto it and re-send that freight movement back through the routed order interface to the EX module. The EX module then re-tenders the order (identified in the EX database as a new order which is related to the old order having the routed tender or accepted status in the database) and the carrier would then determine whether it could handle the updated order. In the event that the updated order could be handled the execution updates the new orders record in the EX database. In the event that the updated freight movement could not be handled by the carrier, the EX module sends the updated order back to the problem-solver and removes the original order from the PS database such that changes to that trip are now not allowed. Alternatively, the PS can then try to re-tender the updated order to a new carrier and, if accepted, cancel the original order.

Referring to FIG. 7, at sub-step 704 the rates for each proposed route from sub-step 703 is calculated using the rate tables stored in the PS database 302. TL rate tables specify shipping rates for each carrier by equipment class. The rate is then specified in each table in terms of dollars per mile, a minimum rate, and/or a flat rate.

LTL rates are specified by carriers for each class in terms of a minimum rate and weight breaks. Package rates are specified for a carrier's weight breaks and charges for transportation within a particular zone. (The zones being defined by a particular carrier). Rail rates, air rates and package rates can be defined as a combination of any of the above. Intermodal freight movements are rated using a particular carrier type rating tables for each leg of the trip.

With respect to TL and LTL rating, the PS module must be able to determine a calculated distance that the shipment will travel from the origin to its destination. As will be readily appreciated by one of ordinary skill in the art, the PS module can be readily adapted to use calculated distances obtained from latitudes and longitudes, zip codes, or street addresses as inputs into a readily available commercial distance calculation software such as PC*Miler and MileMaker.

The rate tables for each carrier type also typically depends on one of two variables (or sometimes both), distance from origin to destination and weight of the freight. With respect to distance traveled, the PS system supports five types of rating methods for TL trips. They are flat rate, metric rate, fixed plus variable rate, mileage rate, and radial rate. A radial rate is a freight rating and routing method by which freight movement cost is determined using the sum of straight-line distances between each end point on a freight movement's various legs as the distance variable.

With respect to the weight variable used in each of the rate tables, the PS module supports the use of standard weights (i.e., pounds or kilograms) or dimensional weights. In the transportation industry, a dimensional weight is a calculation of the shipment's weight based upon its volume metric standard in addition to its actual weight. Essentially, it acts as a equalizer to ensure that large and bulky, yet lightweight, objects that consume a large portion of a carrier's capacity costs comparatively as much as a more dense yet smaller object. A dimensional weight is calculated by multiplying the length times the width times the height of each package and/or object and dividing that volume by an appropriate dimensional weight divisor. The dimensional weight divisor is specified specifically by each carrier for each of its offered carrier type services. Additionally, the dimensional weight divisor can vary according to the lanes for the transport (e.g., domestic US. export shipments). For example, a typical domestic shipment dimensional weight divisor in the United States (for package dimensions listed in inches) is 194, but for US export shipments the divisor is 166.

Carriers typically require that their rate be determined using the larger of the two weights, that is the dimensional weight or the actual weight of the shipment, to determine the price that they charge. Dimensional weight rating is particularly applicable to industries, such as the high tech industry, wherein many boxes are shipped that each have a fairly low weight. For a multiple-package shipment, a dimensional weight is simply determined by adding the individual dimensional weights for each package together.

Both TL and LTL carriers often provide discounts to hauls that serve as a roundtrip. This helps to limit empty legs by carriers and the carriers therefore often pass their savings on to customers to promote roundtrip bookings.

Accessorial charges are anticipated charges, like in-transit handling fees, fuel surcharges, and import/export charges. For each type of carrier and/or lane and/or location, accessorial charges can be defined in the PS database. After the appropriate rating is calculated for the shipment based upon the carrier, the carrier type, and any appropriate modifications required by roundtrip rating, radial rating, dimensional weighting, etc., the accessorial charges that apply are added on to the end to produce a final “expected” cost.

The PS module can schedule the shipment of small packages or small orders through parcel and express carriers (collectively hereinafter referred to as “package carriers”). Typically, package carriers use rate schedules that divide the area they service into a plurality of zones. Each zone has a set of weight breaks and associated charges. Parcel carriers typically divide the continental U.S. into several zones while express carriers have one zone for the continental U.S. and one set of weight breaks and associated changes.

Package carriers generally offer several levels of service such as one-day delivery, two-delivery, normal ground, and so on. The PS module during the optimization of a order batch process will consider all levels of service for a particular carrier that are relevant to meet the needs of the particular order. Some package carriers charge different rates for deliveries to commercial and residential locations. These rates again will be reflected in the rate tables.

Rail carriers are very similar to TL type carriers in that they often operate seven days a week and their quoted rates (stored in the rate tables of the PS database) are typically specified in the same manners as they are with respect to TL (a rate based solely on distance traveled for an entire trailer and/or rail car). As will be readily appreciated by one of ordinary skill in the art, the use of rail carriers necessarily requires posted rail schedules determine the timing of a particular freight movement rather than distance and driving speeds. Additionally, the use of rail also precludes multiple stops or detours. Logically, intermodal carriers combining rail with TL carriers would necessarily incorporate all the limitations associated with TL and rail carriers. Sea carriers are similar to rail carriers in the respects mentioned above.

Referring again to FIG. 6, it is shown the EX module's execution logic 401 performs several steps after the PS module has generated a freight plan at step 603. First, at step 604 the EX logic sends tender offers (formal requests for shipping services) to the carriers selected by the PS logic during step 603. Preferably, each carrier utilized by the PS logic is electronically connected to the execution module 400 through the tender interface 407 such that tender offers (and subsequent acceptances or declines as described below) can be sent electronically in annotated fashion through EDI, email or the Web. Alternatively, of course, more conventional means such as facsimile or telephone can be employed.

Once received, carriers can review tender offers and electronically provide an acceptance or decline (the EX monitoring this acceptance/decline communication at step 606) of the tender offer to the execution module 400 via response interface 412. The EX logic can then re-route any declined orders back to the problem-solver module 300 as unexecuted orders 411 through unexecuted freight movement interface 410 for selection of a different carrier or transportation solution. As shown in the figure at 607, the EX logic decides whether to send the order back to 607 for re-routing (if there is no response after a preset time or if the tender was declined) or to try re-sending the tender to the carrier (such as to give a carrier a second chance to respond to the tender).

Referring back to FIG. 6, after the EX module 401 receives confirmation that a freight movement has been completed at step 608 (preferably electronically via the shipment status interface 406 as described above with respect to FIG. 4) the FP module 500 receives executed orders 409 from the FPI 405 and the freight payment logic 501 generates freight payment invoices and accounts payable and receivable records, the operations of the freight payment logic being depicted collectively as step 609 of FIG. 6.

As discussed above, the freight payment (“FP”) module 500 performs the following functions: it authenticates shipment invoices prior to payment, allocates invoiced charges to shipments and orders, compares expected charges for freight movements to invoiced charges, bills customers for freight charges, authorizes payment to carriers for completed freight movements, records freight charges and sends data to attached accounting systems, and reports and analyzes freight costs.

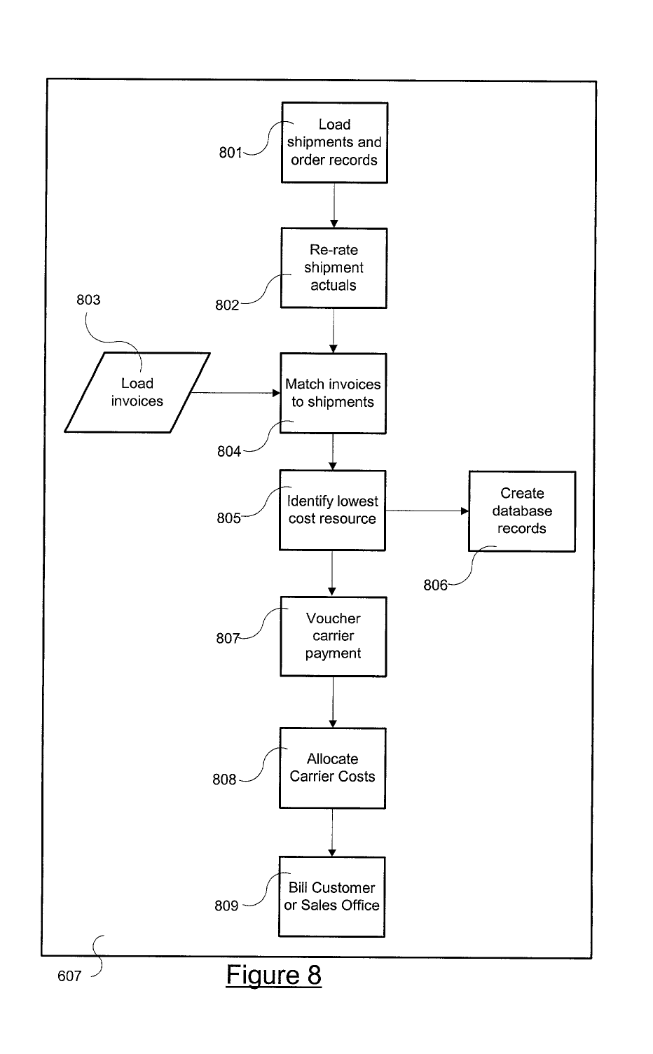

The steps performed by the freight payment logic 501, collectively depicted in FIG. 6 as step 609, in actuality works as a series of sub-steps. FIG. 8 is flow diagram that provides an overview of the sub-steps run by the FP module that make up step 609 of FIG. 6.

Order and shipment information from the EX module (or other upstream electronic execution management system) is routinely loaded at sub-step 801 into the FP module 500 and stored in the FP database 502. These automatically loaded shipment and order records can be viewed at any time by the transportation planning manager 309 through the manager interface 504 at any time. These order records contain all relevant data that was utilized by the PS module 300 in preparing the cost estimate for the freight movement (for example, carrier identity, equipment type, lane, origin, destination, quantity of goods, etc.) as well as data relating to when the freight movement was commenced and completed.

The re-rating sub-step 802 in FIG. 8 recalculates the cost of freight movements once the order records have been successfully loaded into the FP module's FP database 502. The FP module's re-rate sub-process examines variables such as carrier, rates, weight, miles traveled, and accessorial charges and comes up with a cost (virtually identical in manner to that performed by the PS module and described above with respect to sub-step 704 of FIG. 7). It will be readily understood by one of ordinary skill in the art that the FP module could be designed to either utilize the data and logic resident in the PS module to perform this calculation or could alternatively essentially duplicate necessary the data and logic within its own database and logic. While the estimated cost calculated by the PS module when compiling an optimal transportation plan is typically passed to the FP module from the EX module (after the associated freight movement is executed), the FP module recalculates the expected shipment cost at sub-step 802 for several reasons.

First, the estimated carrier cost is recalculated by the FP module because the carrier's expected rates and the accessorial fees represented in the PS database's rate tables may have changed in the intervening period between when the shipment was routed (and thus initially rated) and when the freight movement was actually executed. Second, while the FP module as disclosed above has been discussed as part of a three-module system with the PS and EX modules, the FP module as herein described can be utilized independently of one or both. In such situations wherein the FP module is used as a stand-alone freight payment management system (i.e., not in combination with the PS module and/or EX module as described above) the rate tables and costing processes as described above with respect to the PS module would necessarily have to be incorporated within the FP module. Additionally, of course, there is always the chance that data may become corrupted as it is routed from the PS module.

In the transportation services industry carriers typically supply invoices, or bills, for completed freight movements. Traditionally, invoices were simply paper bills that were mailed from the carrier to the contracting party. According to preferred embodiments of the present invention, invoices are transferred from the carrier electronically, such as via EDI, the Web, or email, and loaded into the FP module at sub-step 803 via the invoice interface 508 as shown in FIG. 5. Additionally, to support carriers that do not transmit invoices electronically, invoice data can be entered into the FP module manually by the transportation planning manager 309 using manager interface 504.

Alternatively, of course, some transportation planning managers may prefer to use shipment status messages, or delivery notices, from carriers as the criteria by which payment of the carrier is authorized.

Once order records have been re-rated at sub-step 802 and the carrier invoices have been received, the FP module matches at sub-step 804 each re-rated order record with an associated invoice. If they can't be matched exactly (for example, if reference numbers on the record and invoice don't match or if a substantial cost difference is found between the invoiced cost and the expected cost), the order and invoice pairs may be tagged for manual review or left unmatched. If a matching invoice cannot be found, the FP module will assume that it hasn't been received from the carrier and try again a preset number of times or will wait for a present amount of time before generating a message for manual review.

The freight payment module 500 attempts to match re-rated shipments to confirmed invoices before vouchering payment to the carrier at sub-step 807. For a successful match, a preset amount of various key fields must be consistent between invoices and order records, such as: the bill of lading (BOL), the SCAC, ship date, weight, origin and destination.

Once executed freight movement records are successfully matched to invoices at sub-step 804, the FP system compares the expected shipping cost (either rated initially by the PS module at sub-step 704 of FIG. 7 or re-rated at sub-step 802 of FIG. 8) with the actual invoiced cost at sub-step 805, and then creates a carrier cost difference database record at step 806 detailing the differences, if any, between the expected and invoiced costs. This carrier cost difference record can be used at later times by the transportation planning manager to revise the rating process such as by updating accessorial charge tables or modifying carrier preference ratings (such as if a carrier's actual invoiced cost typically greatly exceed the calculated expected costs).

Additionally, a company's account department typically needs a voucher notification regarding receipt and verification of an invoice such that they can cut a check to pay the carrier. Once an invoice is identified and verified in the matching sub-step 807, the FP module generates a flat file containing vouchered costs that were incurred by carriers for completed shipments, and this file is outputted (either electronically or in hard copy format) to an accounts payable system at sub-step 807 through accounts payable interface 507. Shipments whose invoices are vouchered at sub-step 807 gain a status of “Vouchered” in database 502 in the FP module 500.

At sub-step 808, the FP module allocates appropriate portions of the actual costs incurred by the carriers (and itemized in the carrier invoices) to the orders that comprise a particular freight movement. As will be readily appreciated by one skilled in the art, invoiced cost allocation is the process of distributing the total cost of a freight movement to the shipments, orders, and/or line items that were in that freight movement. As described above, it is not uncommon for one or more orders from different clients to be combined into a single freight movement by a single carrier. Additionally, carriers often invoice a single amount for their costs. Thus, it is necessary to divide the total cost of a freight movement in a fair manner among the orders that made up the freight movement. The FP module performs capacity allocation and linehaul factors to fairly divide costs.

Linehaul factors are used by the FP module to divide the total freight cost by legs of a trip according to various groupings, including: weight, cube, pallets, distance, weight and distance, cubes and distance, pallets and distance, weight cube factor, and cost savings method. For example, if a freight movement is bearing a weight of 240 for the first leg (Shipment 1) and a weight of 160 for the second leg (Shipment 2), the cost is divided as follows using weight as the linehaul factor:

Total weight (“TWT”) on trip=240+160=400.

Ratio of TWT carried on first leg=240/400=0.60

Ratio of TWT carried on second leg=160/400=0.40

Due to the above allocation calculation, the first leg will be charged for 60% of the freight movement while the second leg will be charged for 40%. Cube and pallets are calculated using the same leg/total ratio method.

Distance may be combined with another factor, such as weight. For linehaul allocations using weight and distance, distance is calculated either by trip mileage (actual distance traveled) or radial mileage (the sum of individual straight-line distances between origin and each stop). For example, for distance and weight linehaul allocation using a trip mileage method, assume that a trip having a total cost of 1000 consists of two legs (with one order being dropped off after each leg). The first leg ending at point S1 has a distance of 200 and a weight of 500 while the second leg ending at point S2 has a distance of 400 and a weight of 900. Using the trip mileage method, the distance to each end point is the total distance traveled, such that:

Distance to S1=200

Distance to S2=600(200 to S1+400 to S2)

The weight distance (“WD”) for each order is then calculated by multiplying the above distances to each respective end point by the weight being dropped of at that end point, such that

WD of S1=(500 weight)*(200 distance)=100,000

WD of S2=(900 weight)*(600 distance)=540,000

Thus, the total weight distance is 640,000. The allocation ratios are then calculated as above with respect to the weight example, such that

Allocation ratio for S1=100,000/640,000=0.156

Allocation ratio for S2=540,000/640,000=0.843

Thus, the order dropped off at S1 accrues 16% of the freight movement cost, and S2 accrues 84%. Linehauls for distance combined with cube or pallets are calculated similarly.

Weight cube factor is available for linehaul allocations in the FP module and determines the following ratios:

Wt%=Order Weight/Total Weight

Cube%=Order Cube/Total Cube

Next, the Weight/Cube Sensitivity Factor (F) is applied. This factor is entered on the FP by the transportation planning manager and can range from zero to one. A score of 0 considers weight only, while 1 considers cube only. A ratio in between will reflect a mix of the two. The allocation percentage is computed as follows:

Allocation%=W%+((C%−W%)×F)

The allocated cost per shipment is then computed as above my multiplying the calculated allocation percentage with the total freight movement cost.

The cost savings linehaul factor, when utilized, causes the FP module to compute the best (standard) direct cost of all deliveries on a multi-stop trip as if they were individual trips from the same origin point. This cost is calculated according to the best-direct cost (i.e., based upon the best rate each individual order could have obtained had it been shipped individually). The ratio of an individual trip's cost to the sum of all standard direct costs for these trips together determines the allocation for that trip. For example, if the origination point is O, and there are three loads with one each destined for off-load points A, B, and C. If the truck were to follow a route from O to A to B to C, then the total trip distance can be represented as:

total distance=(O→A)+(A→B)+(B→C)

where the notation “x→y” represents the distance from point x to y. The allocation ratio for each then would be:

O→A ratio=(O→A)/[(O→A)+(A→B)+(B→C)],

O→B ratio=(O→B)/[(O→A)+(A→B)+(B→C)], and

O→C ratio=(O→C)/[(O→A)+(A→B)+(B→C)].

Again, the allocated cost for each order within the freight movement can be calculated as detailed above from each allocation ratio.

Capacity allocation breaks freight cost down by orders and line items for a given shipment. The FP module can perform capacity allocations according to weight, cube, pieces, pallets, weight/cube factor, and gross sales value ratios. For example, if shipment X has a weight of 1300, and comprises only two orders, order A and order B. If order A has a weight of 500 while order B has a weight of 800, the weight-based capacity allocation per order is as follows:

Order A=500/1300=0.385

Order B=800/1300=0.615

Order A will be allocated 39% of the cost and Order B will be allocated 61% of the cost. Further, if we assume that order A, with a weight of 500, has two line items (sub orders), line-item 1 (weight=400) and line-item 2 (weight=100) the capacity weight allocation for line-item 1 would be 80% (400/500) of the allocation for order A, while line-item 2 would be allocated the remaining 20%.

The weight cube factor, if specified by the transportation planning manager for capacity allocations, uses the following ratio:

Wt%=Order Weight/Total Shipment Weight

Cube%=Order Cube/Total Shipment Cube

The allocation percentage is computed as follows:

Allocation%=Wt%+((Cube%−Wt%)×F)

where F is a present weight/cube sensitivity factor that varies between zero and one. The allocated cost per order is then computed as above.

Finally, referring again to FIG. 8, at sub-step 809, the FP module 500 creates an invoice record reflecting the allocated invoice cost and sends a notification to accounts receivable through the accounts receivable interface 506 (again, either electronically or in hard copy format) to an accounts receivable system through accounts receivable interface 506. Optionally, at this step customer invoices interface 508 can be used to send a version of the order invoice record as a bill (electronically, faxed, printed out for sending by mail, etc.) to the customers 320. The invoicing step operates similarly if the transportation planning manager needs to bill internally (such as to a sales office 318 as shown in FIG. 5 or to sub-divisions, etc.) for a portion of a freight movement.

One of ordinary skill in the art will appreciate that the above optimization, execution and payment handling algorithms may be modified to take into account specific needs and/or problems encountered in particular industries or situations. Thus, the illustrative algorithm should not be construed to limit the present invention as is claimed.

Although the present invention is preferably implemented in software, this is not a limitation of the present invention as those of ordinary skill in the art can appreciate that the present invention can be implemented in hardware or in various combinations of hardware and software, without departing from the scope of the invention. Modifications and substitutions by those of ordinary skill in the art are considered to be within the scope of the present invention, which is not to be limited except by the claims that follow.

The foregoing description of the preferred embodiments of the present invention has been presented for the purposes of illustration and description. It is not intended to be exhaustive or to limit the invention to the precise form disclosed. It will be apparent to those of ordinary skill in the art that various modifications and variations can be made to the disclosed embodiments and concepts of the present invention without departing from the spirit or scope of the invention. Thus, it is intended that the present invention covers the modifications and variations of this invention provided that they come within the scope of any claims and their equivalents.

What is claimed is:

1. A system for managing transportation operations, the system comprising:
means for processing information related to the transportation of a good; and
means for determining an optimal transportation solution for the good using the processed information.

2. The system of claim 1, wherein the information processing means processes order information, carrier information, and constraint information.

3. The system of claim 2, wherein the order information comprises data detailing a client's desires to ship the order, including a source and a destination for the order, a time frame for the delivery of the good, or a type of transport desired for the good.

4. The system of claim 2, wherein the carrier information comprises data related to services that transportation carriers are willing and capable to provide for the good, including a type of transport and prices for transporting the good.

5. The system of claim 2, wherein the constraint information comprises data describing the transportation solutions that are not possible, such as a time windows for transportation of the good, a maximum or minimum capacity, and business goals.

6. The system of claim 1, wherein the determining means produces multiple transportation solutions for the good, wherein each of the solutions proposes an alternative transportation movement for the good.

7. The system of claim 6, wherein the each of the solutions identifies one or more particular carriers and equipment needed to perform the transportation of the good.

8. The system of claim 1, wherein the processing means identifies a lowest cost solution for transporting the good.

9. The system of claim 8, wherein the determining means selects the lowest-cost solution for transporting the good

10. The system of claim 1 further comprising a means to receive an update regarding a status and a location of the shipment.

11. The system of claim 10, wherein the update is in an electronic format.

12. The system of claim 10 further comprising a means for storing the update.

13. The system of claim 12, wherein the update information on the status and the location can then be transmitted to a recipient of the transportation.

14. The system of claim 12, wherein the update storage means is used for external carrier performance tracking, private fleet performance tracking, and equipment tracking to improve a determination of a future transportation solution.

15. The system of claim 1 further comprising means for tendering shipment requests to carriers.

16. The system of claim 15, wherein the tendering means transmits the tenders electronically to the carriers.

17. The system of claim 15 further comprising means for monitoring acceptances of the shipment requests.

18. The system of claim 17, wherein the monitoring means electronically receives acceptances from the carriers.

19. The system of claim 1 further comprising means to receive an accounting from a carrier for an actual cost for the transportation of the good.

20. The system of claim 1 further comprising means to pay to a carrier an actual cost for the transportation of the good.

21. The system of claim 1 further comprising a means to send an invoice to a client for an actual cost of the transportation of the good.

22. The system of claim 1 further comprising means for forming a front-end interface, whereby said front-end user interface permits a transportation planning manager to interact with one or more databases to define a plurality of decision making rules.

23. The system of claim 22, whereby there are multiple transportations, and the front-end user interfacing means permits the transportation planning manager to review and modify files for each transportation.

24. A method for managing transportation operations, the method comprising:
processing information related to the transportation of a good; and
determining a transportation solution for the good using the processed information.

25. The method of claim 24, wherein the step of processing information includes processing order information, carrier information, and constraint information.

26. The method of claim 24, wherein the step of determining a transportation solution includes producing multiple transportation solutions, wherein each of the solutions proposes an alternative transportation movement for the good.

27. The method of claim 26, wherein the each of the solutions identifies one or more particular carriers and equipment needed to perform the transportation of the good.

28. The method of claim 26, wherein the step of determining a transportation solution selects a lowest cost solution for transporting the good.

29. The method of claim 24 further comprising the step of receiving an update regarding a status and a location of the shipment.

30. The method of claim 29, wherein the update is in an electronic format.

31. The method of claim 29 further comprising storing the update.

32. The method of claim 29, wherein the update on the status and the location is transmitted to a recipient of the transportation.

33. The method of claim 29 further comprising using the update for external carrier performance tracking, private fleet performance tracking, and equipment tracking to improve a determination of a future transportation solution.

34. The method of claim 24 further comprising the step of tendering shipment requests to carriers.

35. The method of claim 34, wherein the step of tendering shipment includes transmitting the tenders electronically to the carriers.

36. The method of claim 34 further comprising the step of monitoring the carriers for one or more acceptances of the shipment requests.

37. The method of claim 24 further comprising the step of receiving an accounting from a carrier for an actual cost for the transportation of the good.

38. The method of claim 24 further comprising paying to a carrier an actual cost for the transportation of the good.

39. The method of claim 24 further comprising the step of sending an invoice to a client for an actual cost of the transportation of the good.

40. The system of claim 24 further comprising the step of forming a front-end interface, whereby the front-end user interface permits a transportation planning manager to interact with one or more databases to define a plurality of decision making algorithms

41. The system of claim 40, whereby there are multiple transportations, and the front-end user interfacing means permits the transportation planning manager to review and modify files for each transportation.

42. A transportation operations managing network for managing transportation operations, the network comprising:
a planning module for planning a freight movement between a initial pick-up location and a final drop-off location;
a management module to manage and execute the planned movement with private carrier fleets and/or one or more public carriers; and
a cost module for accrual, accounting and subsequent payment of all shipping costs incurred.

43. The network of claim 42, wherein the planning module uses a load building algorithm to identify and compare possible alternative freight movements from various potential route and stop sequences, modes of transport, and carriers.

44. The network of claim 42, wherein the planning module has decision making rules, and the decision making rules and the information used by the planning derive from business parameters that a transportation planning manager establishes for the system and from carrier availability and rate table information provided by external or fleet carriers.

45. The network of claim 44, wherein the information provided by the transportation manager includes policies or operational requirements and the planning module performs various planning decisions before reaching an optimal transportation plan.

46. The network of claim 42, wherein the planning module consolidates several movements into a single transportation load.

47. The network of claim 46, wherein the planning module determines a best shipping mode for the transport load, including a identifying a carrier, an equipment type, or a route for the transport load.

48. The network of claim 46, wherein the planning module determines and routes that meet delivery time requirements and other business constraints.

49. The network of claim 46, wherein the planning module identifies lowest-cost alternatives to make the planned freight movements.

50. The network of claim 49, wherein the planning module generates an efficient load consolidation and identifies a least-costly carrier and private fleet assignment within constraints imposed by orders and a transportation planning manager.

51. The network of claim 42 further comprising the a front-end interface, the front-end user interface permitting a transportation planning manager to interact with one or more databases to define a plurality of decision making algorithms

52. The network of claim 51, whereby there are multiple movements, and the front-end user interfacing means permits the transportation planning manager to review and modify files for each transportation.

53. A computer program product for managing transportation operations, the computer program comprising:
a computer readable program code configured for planning a freight movement between a initial pick-up location and a final drop-off location;
a computer readable program code configured for managing and executing the planned movement with private carrier fleets and/or one or more public carriers; and
a computer readable program code for accrual, accounting and subsequent payment of all shipping costs incurred during the transportation.

54. A program storage device readable by a machine, tangibly embodying a program of instructions executable by a machine to perform method steps for managing transportation operations for a plurality of orders, the method steps comprising:
planning a freight movement between a initial pick-up location and a final drop-off location;
executing the planned freight movement with carriers; and
accounting for shipping costs incurred during execution of the planned freight movement.

55. The program storage device readable by a machine according to claim 54, wherein said planning step comprises the sub-steps of generating a plurality of potential freight movements to satisfy each order and identifying the lowest cost freight movement from said plurality of potential freight movements.

56. The program storage device readable by a machine according to claim 55, wherein said plurality of potential freight movements are of types selected from the group consisting of direct routes from origin to destination, indirect routes that include a single through-point through which said order is routed, and multiple-leg routes through that include two or more through points through which said order is routed.

57. The program storage device readable by a machine according to claim 56, wherein said through-points are selected from set of predefined through-points for a given transportation lane.

58. The program storage device readable by a machine according to claim 55, wherein said potential freight movements identify a proposed route and a proposed carrier for each order.

59. The program storage device readable by a machine according to claim 54, wherein said executing step comprises the sub-steps of sending tender offers to a proposed carrier indicated by said planned freight movement, receiving acceptance/decline responses from said proposed carrier, and receiving status updates from said carrier and from locations during and after the execution of said freight movement.

60. The program storage device readable by a machine according to claim 59, wherein tender offers are sent to said proposed carrier electronically.

61. The program storage device readable by a machine according to claim 59, wherein
acceptance/decline responses from said proposed carrier are received electronically.

62. The program storage device readable by a machine according to claim 59, wherein said status updates are used to automatically update records contained in an order database, said database being accessible by customers, carriers, and locations to review the status of select orders.

63. The program storage device readable by a machine according to claim 54, wherein said accounting step comprises the sub-steps of receiving invoices from carriers for executed freight movements, allocating actual costs detailed in said invoices to orders, and vouchering carrier payment.

64. The program storage device readable by a machine according to claim 63, wherein said vouchering sub-step comprises comparing said actual costs to expected costs calculated in said planning step, matching invoices with orders, and authorizing payment of said invoice amount to a relevant carrier if said actual costs do not substantially exceed said expected costs.

65. A network of manager modules for planning, executing and paying for freight movements necessitated by a plurality of orders, said network comprising:
a problem-solver module, said problem-solver module being adapted to accept carrier services information from potential carriers and business preferences information from a network user, said problem-solver module being further adapted to accept said orders and construct optimal freight movements from said orders based upon said carrier services information and said business preferences information;
an execution module, said execution module adapted to send tender offers to carriers associated with said optimal freight movements by said problem-solver module and to schedule said optimal freight movements for execution, and further adapted to track status of freight movements during execution; and
a freight payment module, said freight payment module being adapted to allocate invoiced costs received from carriers to appropriate orders and authorize payment of said invoiced costs to a relevant carrier.

66. The network according to claim 65, wherein said problem-solver constructs said optimal freight movements in batch runs, and wherein said batch runs comprise generating a plurality of potential freight movements to satisfy each order, and then identifying the lowest cost freight movement from said plurality of potential freight movements.

67. The network according to claim 66, wherein said problem-solver module, said execution module, and said freight payment module each have at least one electronic interface to transfer data to or from said potential carriers.
